(19) United States
(12) Patent Application Publication
(10) Pub. No.: US 2006/0170235 A1
(43) Pub. Date: Aug. 3, 2006

(54) Vehicle floor door

(76) Inventors: John Forrest Oilar, Novi, MI (US); Mark Borys, Howell, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/045,643

(22) Filed: Jan. 28, 2005

(51) Int. Cl. B60R 7/04

(52) U.S. Cl. 296/37.14

(57) ABSTRACT

A door assembly for providing access to a cavity in a floor of a vehicle, the vehicle having a forward seat and a rearward seat. The door assembly includes a first panel adapted to be hingably connected to one of a first end and a second end of the cavity; a second panel; and an intermediate panel adapted to be hinably connected to at least one of the first panel or the second panel. The intermediate panel may be adapted to provide access to the cavity independently of a location of the forward seat, and each of the first panel, the second panel and the intermediate panel comprise a surface of the vehicle floor when the door assembly is closed.

### BACKGROUND

1. Technical Field

The invention relates in general to a door structure for use in a vehicle, and in particular to a door assembly comprising at least two panels hingably connected that provide access to a cavity defined in the vehicle floor.

2. Description of Related Art

Vehicles, including without limitation, station wagons and recreation vehicles are often purchased for their large carrying capacity. This carrying capacity includes the transportation of passengers and various sizes and amounts of cargo. Many vehicles are provided with one or more retractable seats that often provide additional storage capacity.

A major drawback with many of the retractable seats is that separate manipulation of multiple parts is often required in order to achieve full retraction of the vehicle seat and the cumbersome maneuvering often associated therewith.

Prior attempts have introduced retractable seat members that fold into a storage compartment within the floor of the vehicle. Referring now to FIG. 1, a conventional storage compartment for storing a seat assembly is illustrated. A planar door extends over the storage compartment. The door provides access into the storage compartment. Access into the storage compartment is attained by rotating an end panel proximate to a rearward seat of the planar door upwards on a single hinge and folding the first panel upon the remainder of the planar door. The hinge allows the door to be opened independent of the location of the rearward seat and provides clearance for the continued opening thereof. Due to the size constraints imposed by the position of the rearward seat, the end panel only provides limited access to the cavity. Otherwise, a portion of the rearward seat would impede the opening of the end panel. This access allows the seat that is illustrated proximate to the storage compartment to fold thereinto.

At times, when the seat is not stowed within the storage compartment, the storage compartment may be utilized to store other articles. For example, a family may store their lunch, including their favorite beverages, within the confines of the compartment. However, entry into the storage compartment may be difficult or impossible due a seat proximate to a connecting hinge of the storage compartment blocking the opening of the compartment by covering the connecting hinge that connects the storage compartment door to the vehicle floor, particularly when the seat is moved towards a fully rearward position. Thus, the arrangement prohibits the full rotating range of the storage compartment door and prohibits entry into the compartment.

Thus, there is a need for a storage compartment that is cost-effective and sufficiently strong to withstand the load requirements for automotive applications, while providing access to the storage compartment at all times.

### SUMMARY

The inventors of the present invention have recognized these and other problems associated with vehicle floor door assemblies and have developed a door assembly comprising a first panel having a first end and a second end, at least one second panel, wherein one of the at least on second panel has a first end and a second end, wherein the second end of the first panel is hingably connected to the first end of the one of the at least one second panel, and wherein the first panel is adapted to hingably connect to at least one of the first end and the second end of the cavity, and an end panel hingably attached to the at least one second panel, wherein the first panel, the second panel, and the end panel are adapted to substantially extend over the cavity to form at least a portion of the vehicle floor when in a closed position.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout several views.

FIG. 1 is a conventional storage compartment and floor door arrangement;

FIG. 2 is a perspective view of a door assembly in a vehicle according to an embodiment of the invention;

FIG. 3 is a side view of the door assembly from FIG. 2, and illustrates some positions of the load floor door according to an embodiment of the invention; and

FIGS. 4 and 4A are side views of the door assembly from FIG. 2, and illustrate the seat within a cavity including the door assembly substantially extending thereover, according to an embodiment of the invention.

### DETAILED DESCRIPTION

It should be emphasized that the above-described embodiments of the present invention, particularly, any “preferred” embodiments, are only possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

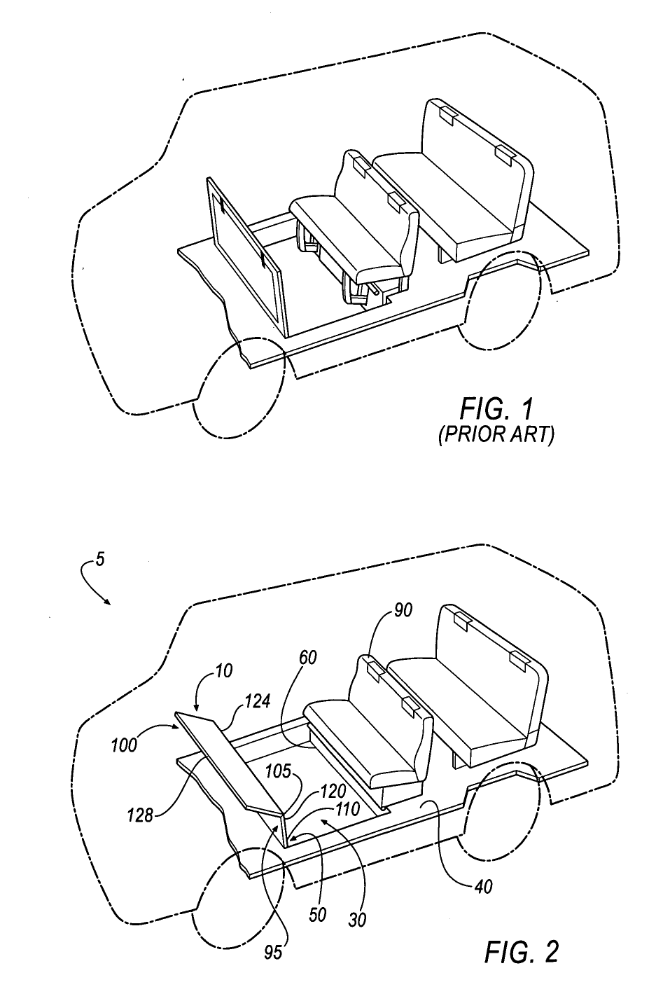

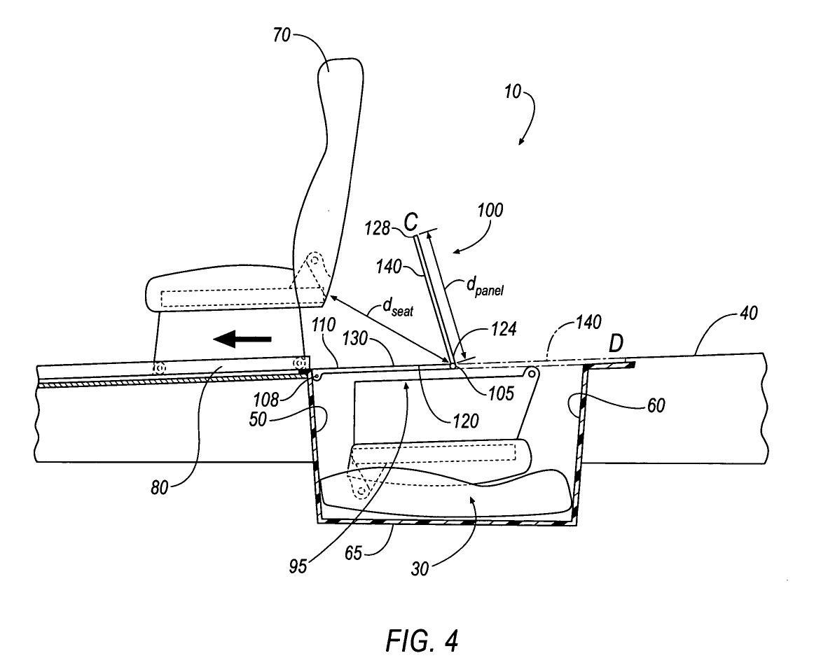

Referring now to FIGS. 2-5, wherein like numbers represent like elements, a perspective view of an automotive vehicle 5 is shown in phantom with a door assembly 10 in accordance with the present invention. The vehicle 5 includes a cavity 30 disposed within a floor 40 of the vehicle 5. The cavity 30 is defined by a first side wall 50, a second side wall 60 and a bottom wall 65. In the illustrations, the first side 50 is proximate to a forward seat 70, and may extend under at least a portion of a forward seat 70, particularly when the forward seat 70 is positioned in a fully rearward position as in FIG. 4. A set of guide rails 80 provide slidable movement for the forward seat 70.

Referring now to FIG. 2-5, the second side 60 of the cavity 30 extends to a rearward seat 90. However, it will be appreciated that the invention may be practiced independent of the extension of the second side 60 of the cavity 30 and the location of the second side 60 should not be limited thereby. It should also be noted that the cavity 30 may be used for purposes other than seat storage, and the invention should not be limited to such. That is, the cavity 30 is capable of storing any desired cargo that can fit within the cavity 32.

The door assembly 10 is adapted to substantially cover the cavity 30. In FIG. 2, the door assembly 10 includes a first panel 95, a second panel 100, an end panel 103, and first and second intermediate hinges 105, 107 therebetween. The first panel 95 includes a first end 110 and a second end 120. Similarly, the second panel 100 includes a first end 124 and a second end 128. The first intermediate hinge 105 hingably connects the second end 120 of the first panel 95 with the first end 124 of the second panel 100. The second intermediate hinge 107 hingably connects the second panel 100 to the end panel 103. In combination, the end panel 103 and the second intermediate hinge 107 allow the door to be opened independent of the location of the rearward seat. Otherwise, a portion of the rearward seat would impede the opening of the door, as characterized hereinabove. Additionally, the first end 110 of the first panel 95 is capable of hingably attaching the door assembly 10 to the first side wall 50 of the cavity 30. In the illustration, a main hinge 108 hingably connects the first side wall 50 of the cavity with the first end 110 of the first panel 105.

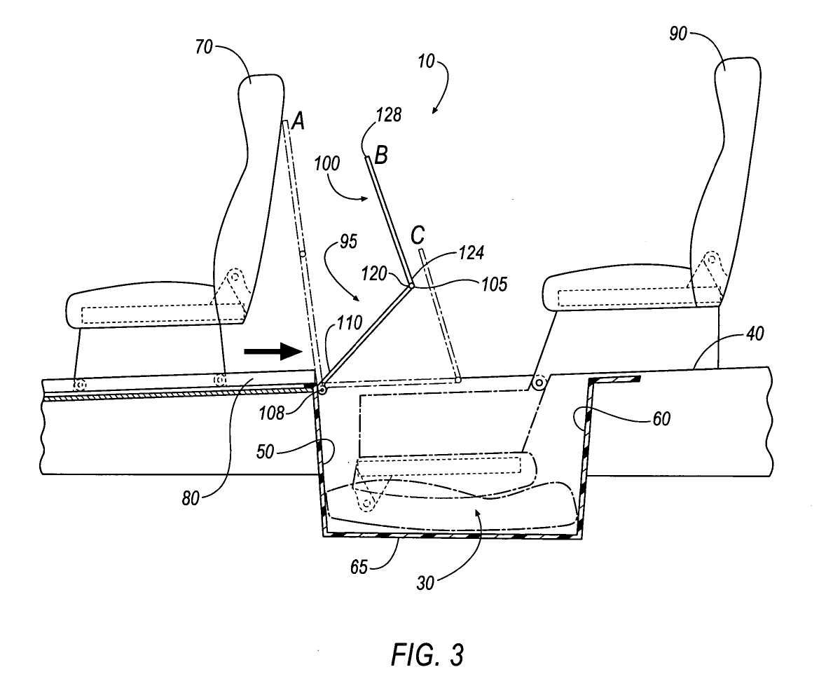

With combined reference now to FIG. 1 and FIG. 3, after considering the present disclosure, it will be appreciated that the door assembly 10 of the invention substantially overcomes at least some of the access problems described above and associated with the door from FIG. 1 and other prior art vehicle storage compartments. FIG. 3 illustrates the movement of the first panel 95 in relation to the second panel 100. The first intermediate hinge 105 provides clearance for fall rotation of second panel 100 so that the second panel 100 is foldable upon first panel 95. Also, the end panel 103 may be folded thereunder such that the door assembly 10 forms a tri-fold, or the end panel 103 may not be folded and extend over the first panel 95.

In the illustrations of FIGS. 4 and 4A, the distance from the first intermediate hinge 105 to the closest article of forward seat 70 (dₛₑₐₜ) is just greater than the length of the second panel 100 (dₚₐₙₑₗ) (see FIG. 4A) or the combined length of the second panel 100 and the end panel 103 (see FIG. 4.) This orientation facilitates clearance for the second panel 100 and the end panel 103 so that the panels have full rotation. In this arrangement, therefore, the second panel 100 and the end panel 103 may be folded upon the first panel 95. Thus, this arrangement of the first intermediate hinge 105 and second panel 100 provides increased access to cavity 30 at all possible positions of forward seat 70 along the guide rails 80. It should be noted, however, that it is not necessary for dₛₑₐₜ to be greater than dₚₐₙₑₗ. For example, positioning the intermediate hinge 105 rearward from the forward seat 70 allows the second panel 100 and the end panel 103 to be opened substantially to or beyond ninety degrees with respect to a closed first panel 95. Therefore, any combination of the first intermediate hinge 105 rearward the forward seat 70 is contemplated by the invention.

It should also be noted that although an orientation that relates to providing clearance between the forward seat 70 and the second panel 100 is discussed, the invention described herein could be reversed to provide clearance from a rearward seat when the main hinge 105 is reversely connected to the second side 60 of the cavity 30. Thus, when considering the present disclosure and the principles described herein, one of ordinary skill in the art will understand how to arrange the invention to accomplish such a result.

It will also be appreciated that many conventional types of hinges or other similar alternatively plausible structures are known and may be used to hingably connect the first panel 20 to the second panel 30. Therefore, the first and second intermediate hinge 105, 107 and the main hinge 108 will only be generally referenced to herein. In the same manner, one of ordinary skill in the art will also readily recognize, when considering the present disclosure, that the invention should not be limited by the disclosed hinge and substitute the appropriate hinge therewith.

With continued reference to FIG. 3, four possible door assembly 10 positions are illustrated. The first panel 95 and the second panel 100 of door assembly 10 may be maneuvered as shown and therebetween. In the first position (A), the first, second, and end panels 95, 100, 103 are open such that the door assembly 10 allows full access into the cavity 30. The second panel 100 and the end panel 103 are tri-folded upon the first panel 95. In the third position (C), the first panel 95 is closed and the second and end panels 100, 103 are open to provide access into the cavity 30, even when the forward seat 70 may not provide full access to the cavity 30 shown in position (A). It should be noted that the end panel 103 may already be completely folded into the second panel 100 at this point. In the second position (B), the first panel 95 and the second panel 100 are between positions (A) and (C) and the end panel 103 is folded under the second panel 100. That is, the first panel 95 is partially open while the second panel 100 and end panel 103 are partially open as well. In the fourth position (D) the first and second panels 95, 100 are closed and the end panel 103 is partially open. Position (D) highlights the ability of the end panel 103 to clear the rearward seat as discussed hereinabove.

Referring now to FIG. 4, the door assembly 10 extends substantially over the cavity 30 at (E). The drawing illustrates the inability for the first panel 95 to clear the forward seat 70 to a fully open position, but the second panel 100, and the end panel 103 are able to clear the forward seat 70 thereby providing access to the cavity. This aspect of the invention is unlike the conventional door assemblies that provide very limited access to the storage compartment when the forward seat 70 is positioned over the main hinge 108. In the illustration, the rearward seat 90 is folded into, and resides within the cavity 30. A top surface 130 of the first panel 95, a top surface 140 (in phantom) of the second panel 100, and a top surface 145 (in phantom) of the end panel 103 are substantially flush to one another and also substantially flush with the vehicle floor 40 such that the door assembly 10 is in substantial alignment with the vehicle floor 40.

It should be noted that a decorative covering (not shown) may be mounted to one or all of the first, second, and end panels 95, 100, 103 to provide a more decorative appearance and softer feel to the door assembly 10. The covering may comprise a carpet, or the like, that can be mounted to one or all of the first, second and end panels 95, 100, 103 by use of any suitable means, such as a commercially available adhesive, or the like.

As described above, the invention provides a hingable door assembly 10 suitable for use in the transportation industries.

While the invention has been specifically described in connection with certain specific embodiments thereof, it is to be understood that this is by way of illustration and not of limitation, and the scope of the appended claims should be construed as broadly as the prior art will permit.

1-11. (canceled)

12. A door assembly for providing access to a cavity in a floor of a vehicle, the cavity having a first end and a second end, the vehicle having a forward seat and a rearward seat, said door assembly comprising:
a first panel adapted to be hingably connected to one of the first end and the second end of the cavity;
a second panel; and
an intermediate panel adapted to be hingably connected to at least one of said first panel or said second panel,
wherein said intermediate panel is adapted to provide access to the cavity independently of a location of the forward seat,
and wherein each of said first panel, said second panel and said intermediate panel comprise a surface of the vehicle floor when the door assembly is closed.
and further wherein said second panel provides access to the cavity independently of a location of the rearward seat of a vehicle.

13. (canceled)

14. (canceled)

15. The door assembly from claim 12, wherein one of a first end and a second end of said first panel is hingably attached to one of a first end and a second end of said intermediate panel by a first intermediate hinge.

16. The door assembly from claim 15, wherein a distance between said first intermediate hinge and the forward seat is greater than a length of said intermediate panel such that said intermediate panel is capable of being fully rotated about said first intermediate hinge.

17. The door assembly from claim 15, wherein a distance between said first intermediate hinge and the forward seat is greater than a combined length of said intermediate panel and said second panel.

18. The door assembly from claim 12, wherein the rearward seat is proximate the second end of the cavity, and wherein the cavity is adapted to receive and store the rearward seat.

19. The door assembly from claim 12, wherein said intermediate panel is adapted to be substantially folded onto said first panel to provide access to the cavity.

20. The door assembly from claim 12, wherein said second panel is adapted to be substantially folded onto said intermediate panel to form a combined panel, and wherein said combined panel is adapted to be substantially folded onto said first panel to provide access to the cavity.

21. A method for providing access to a cavity in a floor of a vehicle, the cavity having a first end and a second end, the vehicle having a forward seat and a rearward seat, said method comprising the steps of:
providing a first panel, a second panel and an intermediate panel;
hingably connecting said first panel of a door assembly to one of the first end and the second end of the cavity;
hingably connecting said intermediate panel to at least one of said first panel and said second panel; and
arranging said first panel, said second panel and said intermediate panel about the cavity such that each of said panels comprise a surface of the vehicle floors.
wherein said door assembly is capable of providing access to the cavity independently of a location of the forward seat.
and wherein said intermediate panel is capable of providing access to the cavity independently of a location of the rearward seat of the vehicle.

22. The method of claim 21, wherein said intermediate panel is adapted to be substantially folded onto said first panel to provide access to the cavity.

23. The method of claim 21, wherein said second panel is adapted to be substantially folded onto said intermediate panel to form a combined panel, and wherein said combined panel is adapted to be substantially folded onto said first panel to provide access to the cavity.

24. (canceled)
